(19) United States
(12) Patent Application Publication
(10) Pub. No.: US 2014/0207605 A1
(43) Pub. Date: Jul. 24, 2014

(54) INVITATION-TO-BID MANAGEMENT SYSTEM

(71) Applicant: TEXTURA CORPORATION, Deerfield, IL (US)

(72) Inventors: Patrick J. Allin, Lake Bluff, IL (US); Mateen Khadir, Chicago, IL (US); Franco Turinelli, Chicago, IL (US)

(73) Assignee: TEXTURA CORPORATION, Deerfield, IL (US)

(21) Appl. No.: 13/833,249

(22) Filed: Mar. 15, 2013

Related U.S. Application Data
(60) Provisional application No. 61/755,084, filed on Jan. 22, 2013.

(51) Int. Cl. G06Q 50/08; G06Q 30/06

(52) U.S. Cl. CPC G06Q 50/08; G06Q 30/0611
USPC 705/26.4

(57) ABSTRACT

A system is described that provides a single dashboard that organizes and displays all invitations-to-bid that have been received by a user from all of their various bid opportunity sources. The system also provides analytics and report functionality to prioritize invitations-to-bid and identify optimal project opportunities. Based on user-defined criteria, the system can be enabled to automatically respond with an approval or a rejection of certain invitations. In some embodiments, the system provides automatic notifications of bid deadlines to ensure that bid submissions are received on time.

### RELATED APPLICATIONS

This application claims priority to U.S. Provisional Application No. 61/755,084, filed on Jan. 22, 2013 and entitled “INVITATION-TO-BID MANAGEMENT SYSTEM,” the entire contents of which are incorporated herein by reference.

### BACKGROUND

When preparing to submit a bid for a construction project, a general contractor will often invite subcontractors and materials suppliers to submit subcontractor bids that can be included in a larger-scale general contractor bid. There is currently no universal format for the presentment of these invitations-to-bid received from various general contractors for various construction projects. As such, a subcontractor is required to sift through the available information to determine whether to prepare a bid submission in response to the invitation-to-bid or to decline the project opportunity presented in each invitation-to-bid.

### SUMMARY

In one embodiment, the invention provides a centralized resource for subcontractors and other users to track and manage all of their invitations-to-bid. The system allows the user to effectively identify and respond to only the right project opportunities resulting in better efficiency in evaluating invitations-to-bid and improved decision making and risk management.

In some embodiments, the invention provides a single dashboard that organizes and displays all invitations-to-bid that have been received by a user from all of their various bid opportunity sources. The system also provides analytics and report functionality to prioritize invitations-to-bid and identify optimal project opportunities. Based on user-defined criteria, the system can be enabled to automatically respond with an approval or a rejection of certain invitations. In some embodiments, the system provides automatic notifications of bid deadlines to ensure that bid submissions are received on time.

In another embodiment, the invention provides a system for managing invitations to bid on construction projects. The system includes a processor and a memory that stores instructions that are executed by the processor to control the operation of the system. The system displays a list of a plurality of projects opportunities each corresponding to an invitation requesting the first participant to submit a bid package for a construction project. The system electronically receives a first invitation from a second participant requesting the first participant to submit a bid package for a construction project to be conducted by the second participant. The system then adds the first project opportunity corresponding to the first invitation to the list of the plurality of project opportunities displayed to the first participant. The first participant can then respond to the invitation by indicating whether they intend to submit a bid package for the first project opportunity.

The system is also configured to electronically receive information from the first participant regarding a second project opportunity corresponding to a second invitation received from a third participant requesting the first participant to submit a bid package. The system receives the project opportunity details for the second project opportunity from the first participant instead of the third participant because the third participant sent the second invitation through channels outside of the system (e.g., email or fax). However, after the project opportunity details are entered by the first participant, the second project opportunity is still added to the list of the plurality of project opportunities displayed to the first participant.

Other aspects of the invention will become apparent by consideration of the detailed description and accompanying drawings.

### BRIEF DESCRIPTION OF THE DRAWINGS

FIG. 1 is a block diagram of a networked invitation-to-bid management system according to one embodiment.

FIG. 2 is a dashboard user interface for the invitation-to-bid management system of FIG. 1.

FIG. 3 is project opportunity interface for the invitation-to-bid management system of FIG. 1.

FIG. 4 is a project opportunity detail entry interface for the invitation-to-bid management system of FIG. 1.

FIG. 5 is a user preference entry interface for the invitation-to-bid management system of FIG. 1.

FIG. 6 is an interface for editing preferred and non-preferred general contractor lists for the invitation-to-bid management system of FIG. 1.

FIG. 7 is a report interface for the invitation-to-bid management system of FIG. 1.

FIG. 8 is a flowchart illustrating a method of approving and rejecting invitations-to-bid on project opportunities enabled by the invitation-to-bid management system of FIG. 1.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein are for the purpose of description and should not be regarded as limiting. The use of “including,” “comprising,” or “having” and variations thereof herein are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments of the invention may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software (e.g., stored on non-transitory computer-readable medium and executed by at least one processor). As such, it should be noted that a plurality of hardware and software based devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible.

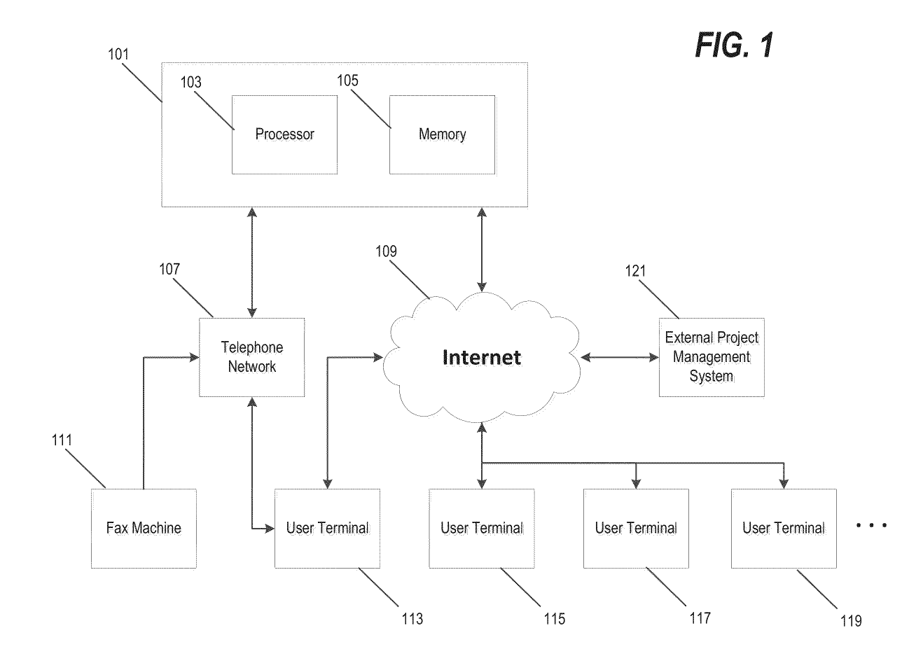

FIG. 1 illustrates one example of a network-based invitation-to-bid management system. A computer server 101 includes a processor 103 and a memory 105. The memory 105 stores a database of project information, user preferences, and other information and also stores instructions that are executed by the processor 103 causing the system to function as described below. Although the memory 105 is illustrated as a single unit, in some constructions, the computer server 101 of the invitation-to-bid management system can include multiple different memory units including, for example, one memory for storing program instructions and another memory for storing the database information. Furthermore, in some other constructions, the computer server 101 stores only the database and a set of utility instructions while the majority of the functionality described below is provided by program instructions executed locally by user terminals (e.g., personal computers) connected to the computer server 101. In still other constructions, program instructions are executed by both the local user terminal and the computer server.

The computer server 101 communicates with external system through one or more network interfaces. In the example of FIG. 1, the available network interfaces include a telephone network 107 and the Internet 109. As described in detail below, the computer server 101 can receive information over the telephone network 107, for example, in the form of communications received from a fax machine 111 or through two-way communication with a user terminal 113. User terminals 113 can also communicate with the computer server 101 through the Internet 109. The computer server 101 is capable of communicating with multiple different user terminals (e.g., user terminals 115, 117, 119, etc.) to provide for distributed access to the invitation-to-bid management functionality. The various user terminals that can be used to access the invitation-to-bid management system can include, for example, a personal computer, a tablet computer, and a smart phone. The computer server 101 can also interface with external project management systems 121 through the Internet 109.

The invitation-to-bid system illustrated in FIG. 1 allows users—typically subcontractors or material suppliers—to track and manage all opportunities that have been presented to the user (e.g., projects for which the subcontractor has been invited to bid by a general contractor). As described in detail below, a user is often invited to bid on several projects at the same time. Furthermore, a user might be invited to bid on the same project by multiple different general contractors. The invitation-to-bid management system described herein allows a user to track the invitations to bid, monitor the project scheduling, and provide an indication to the general contractor regarding whether the user intends to bid on the project or will decline to submit a bid. In some constructions, the invitation-to-bid management system interfaces with a bid submission system to assist the user in creating and submitting bids for projects.

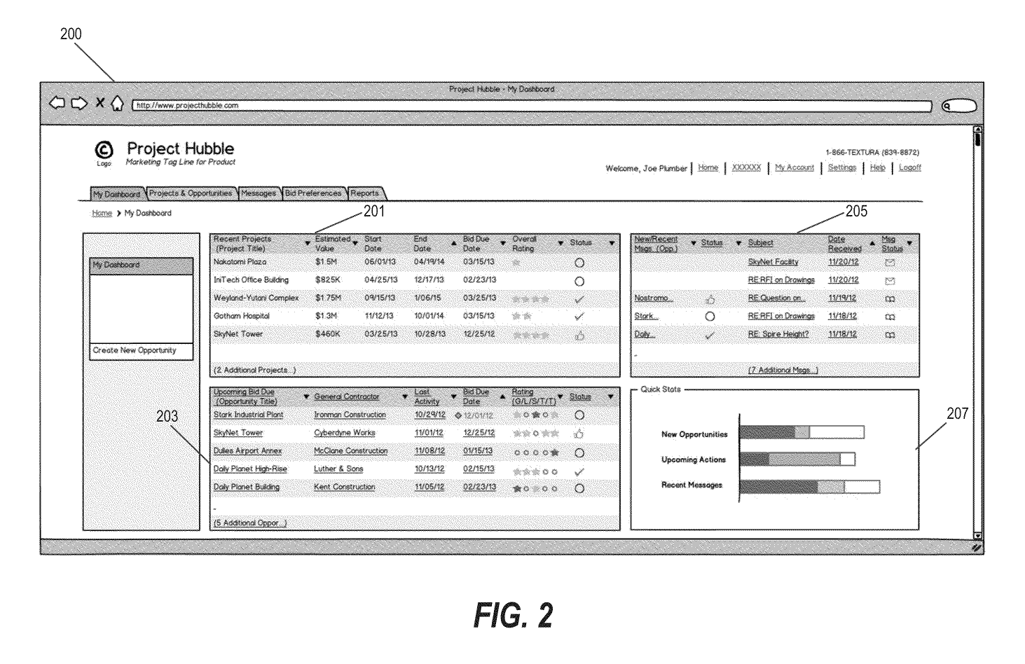

FIG. 2 provides an example of a user interface dashboard 200 that is presented to a user (e.g., a subcontractor or material supplier) when the invitation-to-bid management system is accessed through a user terminal. The user interface dashboard is displayed on a display screen of the user terminal through a web browser, a separate user interface program, or other mechanisms. The user interface dashboard 200 includes a series of tabs near the top of the user interface screen which allow a user to navigate through the invitation-to-bid management system. FIG. 2 illustrates the content of the “My Dashboard” tab. Other tabs are described in further detail below and are illustrated in subsequent figures.

The user interface dashboard screen illustrated in FIG. 2 is displayed as a default screen when a user accesses the invitation-to-bid management system and is also displayed when a user selects the “My Dashboard” tab. The user interface dashboard screen 200 shows four fields: a “recent projects” field 201, an “upcoming bid due” field 203, a messages field 205, and a “quick stats” field 207.

The “Recent Projects” field 201 includes a list of the most recent projects that have been presented to the user in the form of an invitation-to-bid. The field 201 displays a series of columns including a project title, an estimated value of the project, a start date for the project, an end date for the project, an overall rating, and a status. The overall rating is a rating that is either automatically calculated by the system based on defined user preferences or has been assigned manually by the user. Similarly, the “status” field indicates a “status” for the invitation-to-bid that is either automatically assigned by the system or manually determined by the user. The ratings preference and automatic status determinations are described in further detail below.

While the “Recent Projects” tab lists all of the project opportunities that have been presented to the user (i.e., projects for which the user has been invited to bid) in the order that the invitations were received, the “Upcoming Bid Due” field 203 lists the project opportunities in order of the date on which bids are due. The “Upcoming Bid Due” field 203 also displays information in a series of columns including a project title, the general contractor that invited the user to bid, the date of last activity on the invitation, the bid due date, a ratings system, and a status.

The status column in field 203 is the same as the status assigned in field 201. However, the ratings system shown in field 203 is different. Instead of assigning an overall rating to a project opportunity (i.e., a number of stars), the rating system in field 203 assigns stars in each of five categories. The five categories include an evaluation of the GC assigned to the project, the location of the project, the size of the project, the type of the project, and the trade associated with the opportunity. As described in further detail below, each user is able to list opportunity preference information as either “preferred” and “non-preferred.” If the project information corresponding to each of the five categories is in the user's “preferred” list, a gold star is displayed. If the project information is in the user's “non-preferred” list a black star or other notation is displayed. If the project information for a given category is on neither list, then a blank circle is displayed.

For example, field 203 lists an opportunity to bid on the “Stark Industrial Plant” project. The general contractor that invited the user to bid on this project is “Ironman Construction.” Field 203 shows a gold star under the general contractor category for this project thereby indicating that Ironman Construction is on the user's “preferred” general contractor list. However, a black star is displayed under the “size” category indicating that the size of the project is on the user's “non-preferred” list. This indicates that although the user prefers working for Ironman Construction, the user does not want to work on projects of this size (e.g., project is either too large or too small for the user).

Users can also use the invitation-to-bid management system to communicate with general contractors and other users. The “messages” field 205 displays a list of messages and received by the user and notifications that have been generated by the system for the user.

The “quick stats” field 207 provides the user with a high-level summary of current project opportunities in the form of one or more bar graphs. In the example of FIG. 2, the “quick stats” field 207 shows bar graphs for “new opportunities,” “upcoming actions,” and “recent messages. The illustrated bar graphs are three-color graphs illustrating, for example a number of opportunities that have been received as compared to an upper limit defined by the user in a first color. The second color illustrates the number of opportunities for which the user has indicated that a bid will be submitted (or a bid has already been submitted). In other constructions, the three-color bar graph can be used to summarize other information including, for example, a total number of project opportunities received as compared to the number of opportunities that have been reviewed and the number of opportunities that have been acted upon (e.g., accepted or declined).

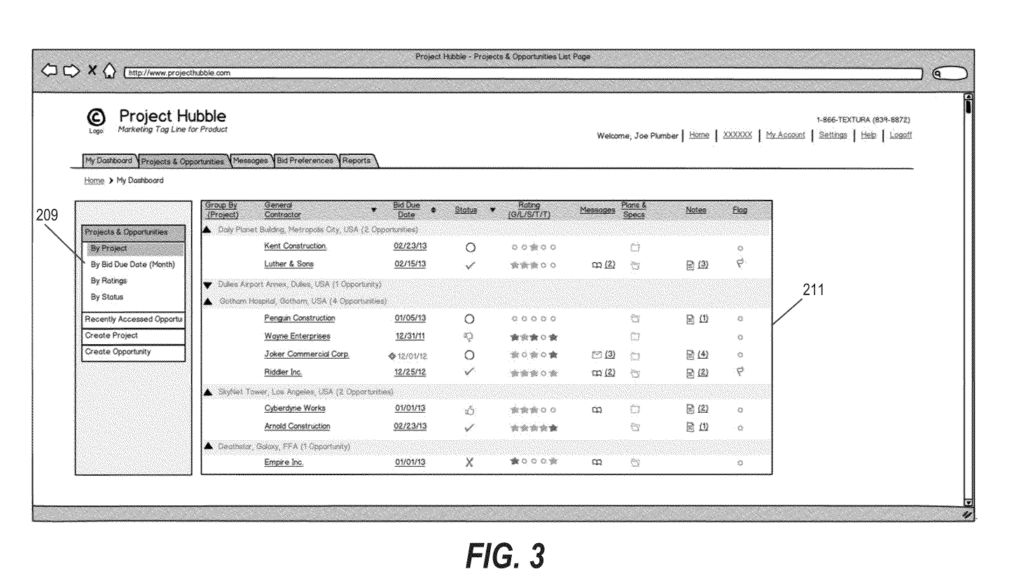

FIG. 3 illustrates the user interface screen that is presented to the user when the “Projects & Opportunities” tab has been selected. On this screen, the system lists all of the projects and opportunities that have been presented to the user. In field 209, the user is able to select a display preference for grouping the opportunities. In the example of FIG. 3, the opportunities can be grouped by project, by bid due date (month), by ratings, or by status. In the example of FIG. 3, the user has selected to display the opportunities grouped by project.

As noted above, a user (e.g, a subcontractor or materials supplier) may be invited by multiple different general contractors to submit a bid for a single project. If a bid is submitted, the general contractor will include the user's bid information in the general contractor bid that is submitted for the project. Because only one general contractor will be awarded the project, a user is typically free to submit subcontractor bids to multiple general contractors for the same project.

In the example of FIG. 3, field 211 lists all of the opportunities that have been presented to the user grouped by project. For example, the first listed project in field 211 is the “Daily Planet Building.” The user has been invited to submit a subcontractor bid for this project by two general contractors—Kent Construction and Luther & Sons. As such, both of these general contractors are listed as “opportunities” under the “Daily Planet Building” project. Additional information for each “opportunity” is listed in a series of columns including the name of the general contractor, a bid due date, a status, an opportunity rating (using the G/L/S/T/T format described above), any messages available for the opportunity, a link to the plans & specs for the opportunity, and a user selectable flag. In this example, the flag has no functional purpose and can be set or removed by the user as a reminder or other indicator. However, in other constructions, the flag can be used as a follow-up reminder or a sorting factor.

As illustrated in FIG. 3, the “status” assigned to each opportunities includes one of five different symbols: a check mark, an X, a “thumbs-up”, a “thumbs-down”, and a blank circle. As described in detail below, a user is able to set certain preference levels for project opportunities. Based on these customized preference levels, the user can enable the system to automatically respond to an invitation-to-bid if certain criteria are met. If the criteria for an automatic response are not met, a user can manually set the status for an opportunity.

A “thumbs up” icon in the status field indicates that the criteria for an automatic approval have been met. A “thumbs down” icon indicates that the criteria for an automatic rejection have been met. A “check mark” indicates that the user has manually approved an opportunity and an X indicates that the user has manually rejected an opportunity. If the criteria for automatic approval or rejection have not been met and a manual approval/rejection has not yet been received, the system displays a blank circle in the status field. As describe in detail below, the system automatically sends a notification to the general contractor when the status has been set or altered for an opportunities.

The invitation-to-bid system described herein can be utilized by general contractors for communicating invitations and other project information to subcontractors and material suppliers. However, many existing general contractors send invitations-to-bid via email, postal mail, fax, or other mechanisms. However, the user can still use the invitation-to-bid management system to manage bid invitations that have been received outside of the system. The user can enter the details of an external invitation-to-bid, for example, by forwarding the invitation to the system via email, faxing a copy of the invitation to the system, or by entering the information manually using a form.

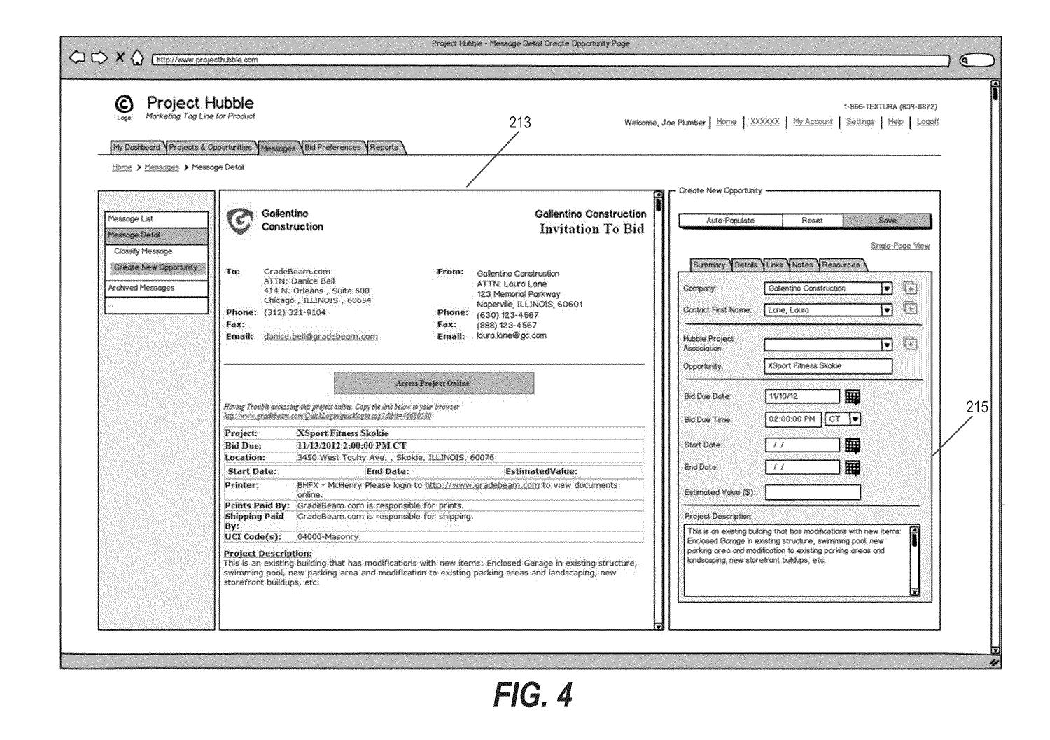

In the example of FIG. 4, the user has received an invitation-to-bid directly from a general contractor via email and has forwarded the email to the invitation-to-bid system. The email is displayed in field 213. Field 215 presents a form that is used by the user to enter information from the email invitation into the invitation-to-bid database. In some constructions, the invitation-to-bid management system attempts to recognize information corresponding to certain fields and automatically fills the corresponding field in the form 215. The user then provides any missing information and corrects any information that was incorrectly added to the form automatically. In some constructions, the system is also able to auto-populate the fields of the form based on previously received information (e.g, other invitations to bid received from this same contractor).

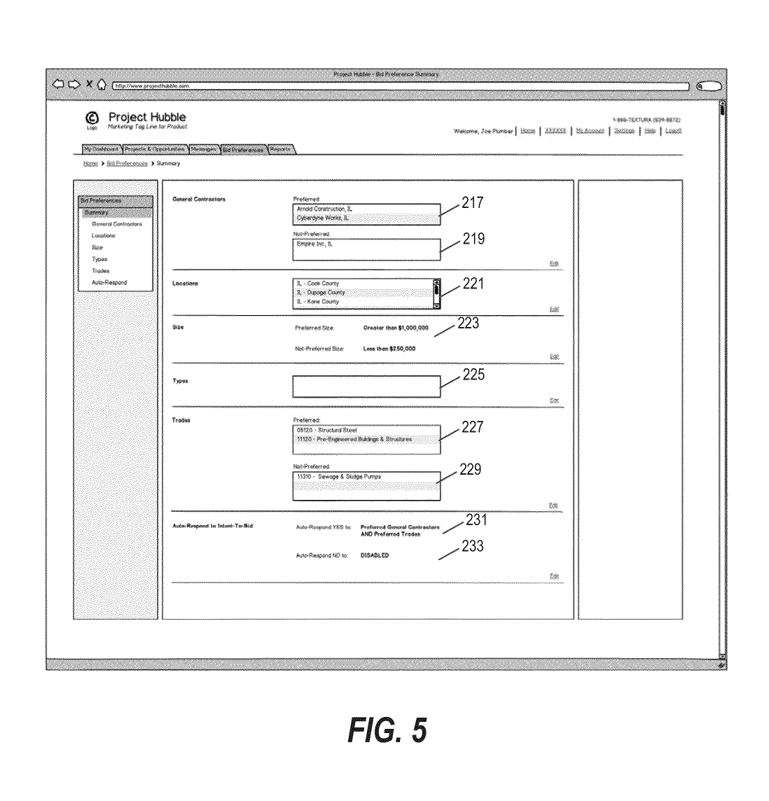

As noted above, a user is able to define certain preferences that allow the invitation-to-bid system to provide an automatic rating for projects and to automatically approve and reject certain opportunities. FIG. 5 illustrates an example of a user preference form that is presented to the user when the “Bid Preferences” tab is selected. Using this form, a user is able to create a list of “preferred” general contractors 217 and a list of non-preferred general contractors 219. The user is also able to list preferred locations 221 for project opportunities and preferred “types” of projects (e.g., new constructions, remodeling, etc.). The user is also able to build a list of preferred trades 227 and a list of non-preferred trades 229.

As noted above, the user preference information that is defined using this form is used by the system to apply a rating to each project opportunity. However, a user can also choose to enable the system to automatically approve or reject certain opportunities based on provided user preference information. In the example of FIG. 5, the user has entered automatic approval information in field 231 indicating that the system is to automatically approve invitations that are received from a preferred contractor for work included in a preferred trade. The user has entered automatic rejection information in field 233 indicating that automatic rejections are not to be sent by the system. The automatic approval/rejection information entered into fields 231 and 233 can be customized by each user. For example, a user can enable the system to automatically reject all projects from non-preferred general contractors and automatically reject all projects below a certain size by entering “Non-Preferred General Contractors OR Non-Preferred Size” in field 233.

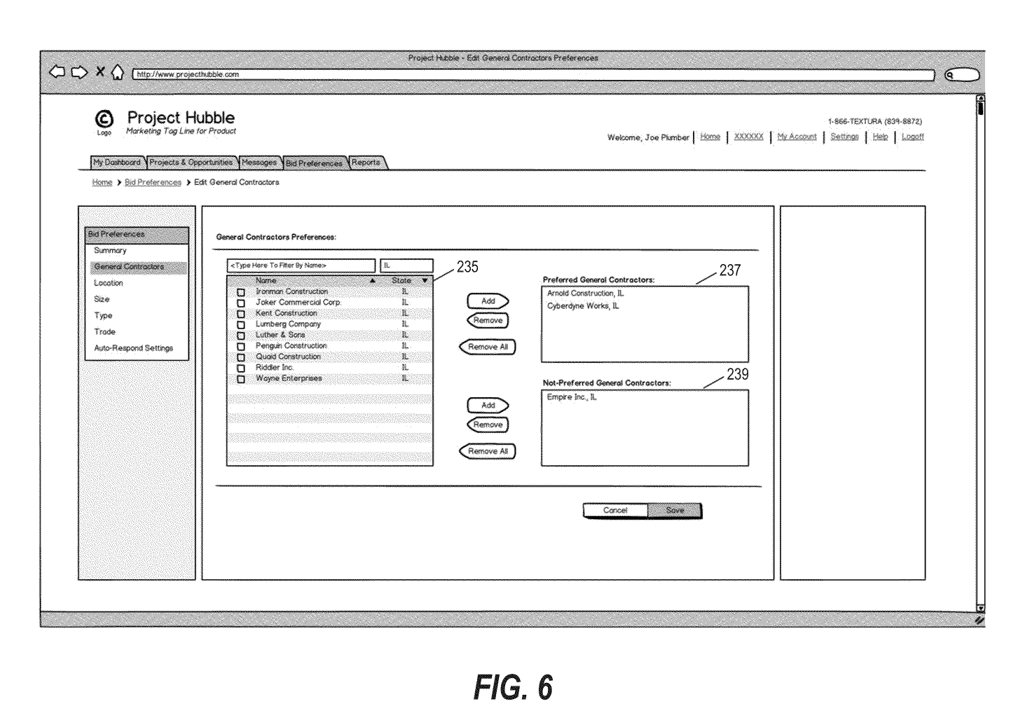

Some of the fields presented on the form of FIG. 5 can be edited by directly entering text in the field. However, in some constructions, some of the fields are populated through another interface. For example, in some constructions, the screen illustrated in FIG. 6 is displayed when the user selects field 217 or field 219. Field 235 of FIG. 6 provides a list of all of the general contractors registered with the system. In some constructions, this list can be edited by the user while, in other constructions, the list includes a static listing of general contractors that cannot be edited. In still other constructions, the list includes only general contractors that have previously invited the user to submit bids. The user can add or remove general contractors to the preferred general contractor list (field 237) using the buttons to the left of the field. Similarly, a user can add and remove general contractors to the non-preferred list (field 239) using the buttons to the left of that field.

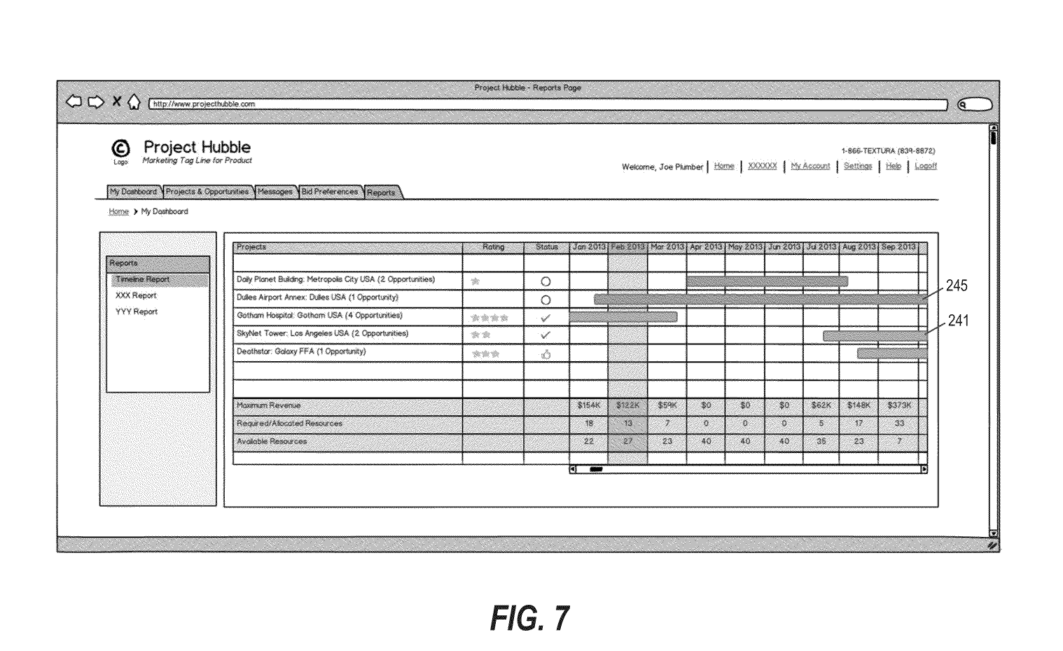

The invitation-to-bid management system can also be used to generate and display summary reports for a user when the “Reports” tab is selected. FIG. 7 illustrates an example of a “timeline report” that can be generated by the system and displayed to the user. The timeline report lists each “project” for which the user has been invited to bid. If the user has agreed to submit a bid for a project (or has already submitted a bid for the project), the timeline is blocked out in a first color for the duration of the project (see, e.g., 241). The system also shows the timeline blocked out for pending project invitations in a second color (see, e.g., 245). In some constructions, the report can include additional colors to indicate other project statuses. For example, a third color can be included in the report to differentiate between projects for which the user has submitted a bid and projects that have already been awarded to the user. This report format allows a user to visually see existing commitments to more easily determine whether the user has capacity to bid on another existing project opportunity.

Along the bottom of the report, the report displays “maximum revenue,” a total of required resources for committed projects, and a total of available resources for additional projects for each month. For example, according to the report of FIG. 7, the user has committed to the Gotham Hospital project and has an opportunity to bid on the Dulles Airport Annex project. Due to the existing commitment, the user has already allocated 13 workers to the Gotham Hospital project for February 2013. Because the user has 40 total workers available, he has 27 available workers that could be allocated to the Dulles Airport Annex project in February. Furthermore, based on the report, the user is able to determine that none of his workers have been allocated for any projects in April 2013, but the user has opportunities to bid on two projects during that period where workers could be allocated and revenue gained.

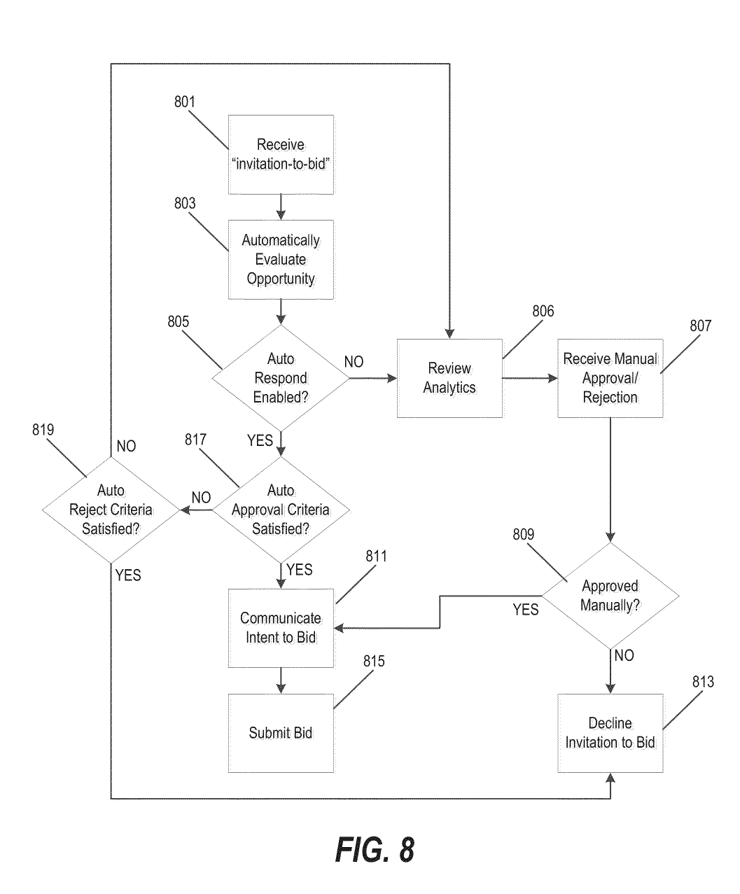

As described above, the invitation-to-bid management system enables a user (e.g., a subcontractor or materials supplier for construction projects) to track and manage all available opportunities for which the user has been invited to submit bids. Furthermore, by allowing a user to define certain bid preference information and automatic approval/rejection rules, the system assists the user in managing bid invitations by providing a rating systems and automatically responding to certain invitations. FIG. 8 illustrates the approval/rejection process in further detail.

The system receives an invitation-to-bid on a project directed toward the user (step 801). As described above, this invitation can be received directly through the invitation-to-bid interface, from an external project/bid management system, or through an external communication directly to the user. Based on the project information included in the invitation-to-bid and the previously defined user preference information, the system automatically evaluates the opportunity (step 803). If automatic response have been disabled or if a user has declined to define automatic response rules (step 805), the opportunity is included in the user's opportunity list and the status is marked with an open circle icon (indicating that a status has not yet been assigned). The user accesses the system and is able to review analytic reports (for example the automated rating system discussed above) and other information about the specific project opportunity (step 806). After reviewing the details of the project opportunity, the user manually approves or rejects the opportunity (step 807). If the opportunity is manually approved (step 809), the status of the opportunity is marked with a “check mark” as noted above and the system sends a notification to the general contractor indicating that the user intends to submit a bid for the project opportunity (step 819). However, if the user manually rejects the invitation-to-bid, the system marks the status of the opportunity with an “X” and sends a notification to the general contractor indicating that the user will not be submitting a bid for the project opportunity (step 813).

After the user has accepted an invitation-to-bid for a project, the general contractor will expect the user to submit a bid proposal (step 815). In some constructions, the invitation-to-bid system is incorporated as part of a comprehensive project management system that can be used to prepare and submit a bid for accepted project opportunities. In other constructions, the user is required to prepare and submit a bid separately. In still other constructions, the invitation-to-bid system is configured to export information regarding an accepted project opportunity to an external bid submission system. The exported information is then used by the external bid submission system to automatically populate certain information for the project to assist in the preparation of the bid submission.

FIG. 8 also illustrates an example of a mechanism used by the system to automatically approve or reject project opportunities. If the user has enabled the automatic response feature and defined automatic response rules (step 805), the system proceeds to compare the project information from the invitation-to-bid to the user defined preference information. If the automatic approval criteria defined by the user have been satisfied (step 817), the system marks the status for the project opportunity with a “thumbs up” icon and automatically sends a notification to the general contractor indicating that the user will submit a bid for the project opportunity (step 811). Similarly, if the automatic rejection criteria defined by the user have been satisfied (step 819), the system marks the status for the project opportunity with a “thumbs down” icon and automatically sends a notification to the general contractor indicating that the user will not be submitting a bid for the project opportunity. If the criteria have not been met for either an automatic approval or an automatic rejection, the system does not assign a status to the project opportunity. Instead, the system waits for the user to review the project details and analytic reports (step 806) and to manually approve or reject the project opportunity (step 807).

Thus, the invention provides, among other things, a centralized resource for tracking and managing invitations-to-bid received for a number of different projects from a number of different general contractors. Various features and advantages of the invention are set forth in the following claims.

What is claimed is:

1. A system for managing invitations to bid on construction projects, the system comprising a processor and memory, the memory storing instructions that, when executed by the processor, cause the system to:
display to a first participant on a first display a list of a plurality of project opportunities, each project opportunity corresponding to an invitation requesting the first participant to submit a bid package for a construction project;
electronically receive from the first participant information regarding a first project opportunity, the information regarding the first project opportunity corresponding to a first invitation from a second participant requesting the first participant to submit a bid package for a construction project to be conducted by the second participant; and
add the first project opportunity to the list of the plurality of project opportunities displayed to the first participant; and
electronically receive a response to the first invitation from the first participant, the response to the first invitation indicating whether the first participant intends to submit a bid package corresponding to the first project opportunity.

2. The system of claim 1, wherein the instructions, when executed by the processor, further cause the system to:
electronically receive a second invitation from a third participant, the second invitation requesting the first participant to submit a bid package for a construction project to be conducted by the third participant; and
add a second project opportunity corresponding to the second invitation to the list of the plurality of project opportunities displayed to the first participant.

3. The system of claim 1, wherein the first invitation is received by the first participant through a mechanism separate from the system, and wherein the mechanism includes at least one of a telephone call, a fax, and an email.

4. The system of claim 1, wherein the instructions, when executed by the processor, further cause the system to transmit a notification to the second participant after receiving a response to the first invitation from the first participant, the notification indicating whether the first participant intends to submit a bid package corresponding to the first project opportunity.

5. The system of claim 1, wherein the instructions, when executed by the processor, cause the system to transmit the notification to the second participant based on an email address for the second participant included in the information regarding the first project opportunity received from the first participant.

6. The system of claim 1, wherein the list of a plurality of project opportunities includes opportunities corresponding to more than one invitation to submit a bid package for a single project, and wherein the more than one invitations are received from multiple contractors each preparing a bid for the single project and requesting the first participant to submit a subcontractor bid package to include in a general contractor bid for the single project.

7. The system of claim 6, wherein the instructions, when executed by the processor, further cause the system to group opportunities corresponding to the more than one invitations to submit a bid package for the single project together when the list of the plurality of project opportunities is displayed to the first participant.

8. The system of claim 1, wherein the instructions, when executed by the processor, further cause the system to
electronically receive a second invitation from a third participant requesting the first participant to submit a bid package for a second project opportunity;
access automatic approval criteria for the first participant stored on the memory;
determine whether the second project opportunity meets the automatic approval criteria for the first participant; and
when the second project opportunity meets the automatic approval criteria for the first participant, mark the second project opportunity as accepted in the list of the plurality of project opportunities displayed to the first participant and automatically send a notification to the third participant indicating that the first participant will be submitting a bid package for the second project opportunity.

9. The system of claim 8, wherein the instructions, when executed by the processor, further cause the system to receive a list of preferred general contractors from the first participant, and wherein the instructions, when executed by the processor, cause the system to determine whether the second project opportunity meets the automatic approval criteria for the first participant by
comparing the name of the general contractor corresponding to the second project opportunity to the list of preferred contractors, and
determining that the second project opportunity meets the automatic approval criteria for the first participant when list of preferred contractors includes the general contractor corresponding to the second project opportunity.

10. The system of claim 8, wherein the instructions, when executed by the processor, cause the system to determine whether the second project opportunity meets the automatic approval criteria for the first participant by
accessing a list of preferred characteristics defined for the first participant for each of one or more categories, and
comparing information from the second project opportunity to the list of preferred characteristics for each of the one or more categories.

11. The system of claim 10, wherein the instructions, when executed by the processor further cause the system to determine whether the second project opportunity meets the automatic approval criteria for the first participant by determining that the second project opportunity meets the automatic approval criteria for the first participant when the list of preferred characteristics for at least one of the one or more categories includes the corresponding information from the second project opportunity.

12. The system of claim 10, wherein the instructions, when executed by the processor further cause the system to determine whether the second project opportunity meets the automatic approval criteria for the first participant by determining that the second project opportunity meets the automatic approval criteria for the first participant when the list of preferred characteristics for all of the one or more categories includes the corresponding information from the second project opportunity.

13. The system of claim 10, wherein the instructions, when executed by the processor, further cause the system to:
receive from the first participant a list of preferred characteristics for at least one category of the one or more categories; and
store the list of preferred characteristics for the at least one category of the one or more categories to the memory.

14. The system of claim 13, wherein the instructions, when executed by the processor, further cause the system to consider only the categories of the one or more categories for which a list of preferred characteristics has been received from the first participant when determining whether the second project opportunity meets the automatic approval criteria for the first participant.

15. The system of claim 8, wherein the instructions, when executed by the processor, further cause the system to:
access automatic rejection criteria for the first participant stored on the memory;
determine whether the second project opportunity meets the automatic rejection criteria for the first participant; and
when the second project opportunity meets the automatic rejection criteria for the first participant, mark the second project opportunity as rejected in the list of the plurality of project opportunities displayed to the first participant and automatically send a notification to the third participant indicating that the first participant will not be submitting a bid package for the second project opportunity.

16. The system of claim 1, wherein the instructions, when executed by the processor, further cause the system to automatically assign a score to the first project opportunity.

17. The system of claim 16, wherein the instructions when executed by the processor, further cause the system to display the list of the plurality of project opportunities to the first user in an order based on the score assigned to each project opportunity.

18. The system of claim 16, wherein the instructions, when executed by the processor, further cause the system to:
compare project opportunity information for the first project opportunity to scoring criteria defined for each of a plurality of categories;
assign a point to the first project opportunity for each category of the plurality of categories where the project opportunity information satisfies the defined scoring criteria.

19. The system of claim 18, wherein instructions, when executed by the processor, further cause the system to display a number of stars assigned to the first project opportunity, and wherein the number of stars assigned to the first project opportunity corresponds to a number of points assigned to the first project opportunity.

20. The system of claim 16, wherein the instructions, when executed by the processor, further cause the system to:
compare project opportunity information for the first project opportunity to scoring criteria defined for each of a plurality of categories; and
display an indication of whether the project opportunity information for the first project opportunity satisfies the scoring criteria for each of the plurality of categories when the list of the plurality of project opportunities is displayed to the first participant.

21. The system of claim 16, wherein the instructions, when executed by the processor, further cause the system to
electronically receive a scoring adjustment for the first project opportunity; and
adjust the score assigned to the first project opportunity based on the scoring adjustment.

22. The system of claim 1, wherein the instructions, when executed by the processor, further cause the system to
analyze the project opportunities in the list of the plurality of project opportunities and a plurality of responses received from the first participant to invitations to bid corresponding to project opportunities in the list of the plurality of project opportunities; and
generate a report to assist the first participant in deciding whether to approve or reject the remaining project opportunities in the list of the plurality of project opportunities.

23. The system of claim 22, wherein the report includes a time-line display based on project schedules for each of the project opportunities for which the first participant has accepted an invitation to bid.

24. The system of claim 23, wherein the report further includes a time-line display based on project schedules for each of the project opportunities for which the first participant has not accepted or rejected the invitation to bid.

25. The system of claim 24, wherein the report identifies the project opportunities for which the first participant has not accepted or rejected the invitation to bid that do not conflict with the project schedules for the project opportunities for which the first participant has accepted an invitation to bid.

26. The system of claim 22, wherein the report identifies the project opportunities for which the first participant has not accepted or rejected the invitation to bid that are similar to one or more project opportunities for which the first participant has accepted an invitation to bid.

27. The system of claim 22, wherein the report identifies project opportunities in the list of the plurality of project opportunities that correspond to a project for which the first participant has already accepted at least one invitation to bid.
